(19) United States
(12) Patent Application Publication
(10) Pub. No.: US 2007/0183457 A1
(43) Pub. Date: Aug. 9, 2007

(54) Method for providing secure data transfer in a mesh network

(75) Inventor: Adam S. Leitch, Brighton (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,813

(22) PCT Filed: Mar. 2, 2005
(86) PCT No.: PCT/IB05/50762

§ 371 Date: Sep. 12, 2006

(30) Foreign Application Priority Data
Mar. 17, 2004 (GB) 0406095.0

(51) Int. Cl. H04J 3/00

(52) U.S. Cl. 370/498

(57) ABSTRACT

A mesh network comprises a plurality of data nodes (a-g, e) configured to make direct data transfers to all other nodes (a-g, e) in the network within transmission range. The invention provides a method for making a secure data transfer from one node to another. Each node has already measured the exact time-of-flight to its neighbours and this information has been supplied to the coordinator node (1) or to the transmitting node (s). The transmitting node (s) can determine the time-of-flight along a number of different routes (A-E) through the mesh. The data to be transmitted is chopped up such that the data taking the longest route (E) is sent first, and the data taking the shortest route (A) is sent last. At the receiving end, the data arrives exactly re-ordered in time, and thus no decoding needs to take place. The benefit of this is that even if the transmitting end (s) is monitored, the data (I-V) has already been chopped up when it is transmitted, and at the receiving end (d), the data cannot be interpreted unless co-located onto the same receiving spot, as that is the only place in which the data arrives at the exact time synchronised moment.

The invention relates to the transfer of data in a network. More specifically, it relates to the secure transfer of data using multi-hop transfers in a network.

Wireless networks have many advantages over wired networks and the management of the communication between the nodes in the network is significant to the success of the wireless network. In networks comprising a large number of nodes, it is common that two nodes are not within transmission range of each other, and consequently, the transfer of data between the nodes involves a number of intermediate nodes forwarding the data in a multi-hop transfer. A number of algorithms for making a multi-hop data transfer between a source node and a destination node in a large network are discussed in EP 0637152.

Multi-hop transfers are particularly relevant in networks comprising low power devices, which have a low transmit power and small antennas, thus limiting the communication range of the devices. Such networks have particular relevance for networks connecting electronic equipment in an intelligent home, wherein electronic devices connected to appliances in the home can communicate with each other and with a user. For example, the fridge, the fire alarm and the door lock may all be linked to a network coordinator that in turn is connected through the Internet to the user in a remote location. Other examples of where short-range networks comprising a large number of low power nodes are relevant are commercial and military communication. Devices in these networks may need to run on standard non-rechargeable batteries, be cheap and have a long battery life in order for the networks to be viable. Multi-hop transfers in such network involve a number of problems. Firstly, at each node in the network the data can be intercepted and the use of encryption techniques to increase security results in an increased amount of data being transferred and requires more processing power in both the transmitting and receiving node. The additional processing results in increased power consumption, which in low power networks may not be appropriate. The sophisticated encryption techniques also result in higher maintenance costs and more expensive node devices. Moreover, the encryption keys must in some way be delivered to the destination node and security is compromised if the keys are forwarded by each of the nodes required to forward the message.

The invention seeks to solve these problems

According to the invention there is provided a method of transmitting a message comprising a sequence of ordered data portions between a source node and a destination node in a network, the method comprising assigning a route from a plurality of different routes to each of the data portions, and transmitting each of the data portions at a specific time based on the assigned route and order such that the portions are received in the ordered sequence at the destination node.

Thus, encryption need not be used and the data portions can be received in order. Consequently, less process power can be used to put the message back together. Moreover, the only location in the network where the complete message can be intercepted is at the exact location of the destination node.

Furthermore, in one embodiment of the invention, data portions from the beginning of the ordered sequence are assigned longer routes than data portions from the end of the ordered sequence. Thus, the overall time of transmission of the message is reduced.

Yet further, according to the invention, there is provided a device adapted to be used in a wireless network comprising a plurality of nodes for transmitting a message comprising an ordered sequence of data portions through the network to a destination node, the device comprising transmission means for transmitting each of the data portions along a different route assigned to the data portion and at a different time based on the assigned route and order such that the data portions are received in the ordered sequence at the destination node.

Embodiments of the invention will now be described, by way of example, with reference to the accompanying drawings, in which:

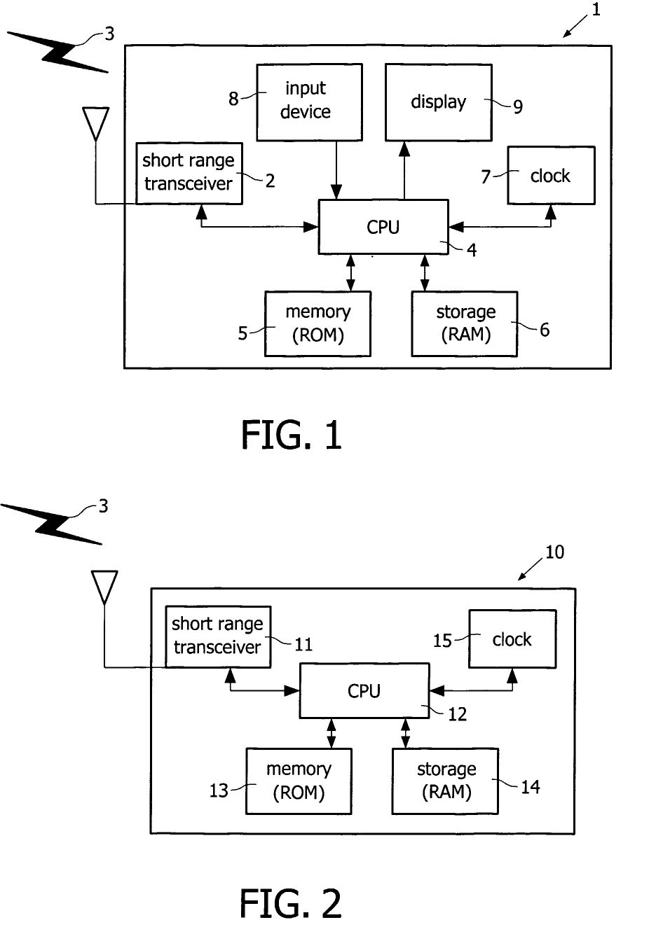

FIG. 1 is a schematic drawing of a low power device suitable for a wireless network;

FIG. 2 is another schematic drawing of a low power device suitable for a wireless network;

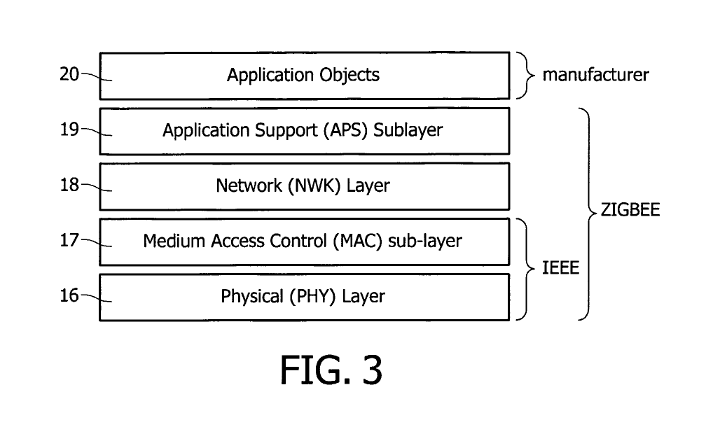

FIG. 3 illustrates the protocol layers in the devices shown in FIG. 1 and FIG. 2;

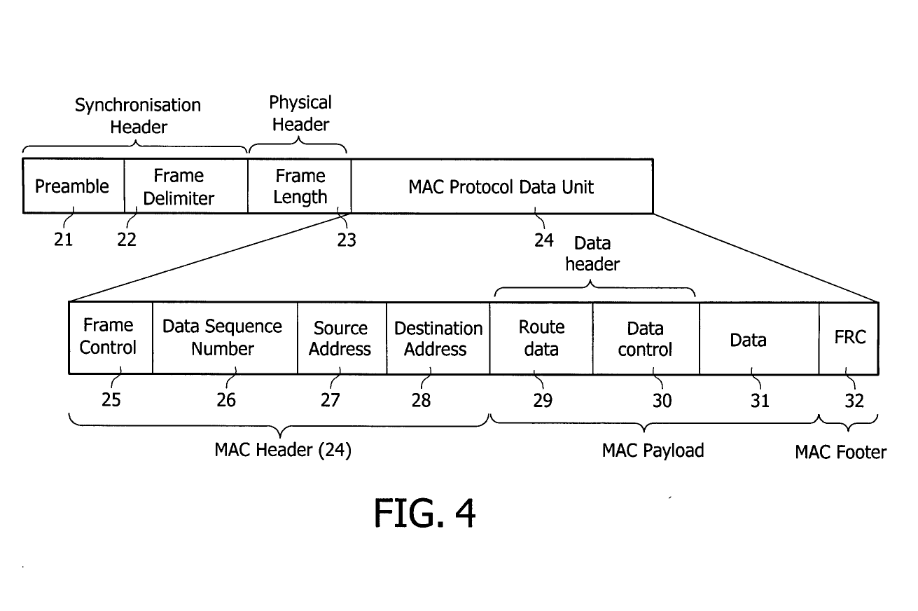

FIG. 4 illustrate the structure of the data units sent between nodes in the wireless network according to one embodiment of the invention;

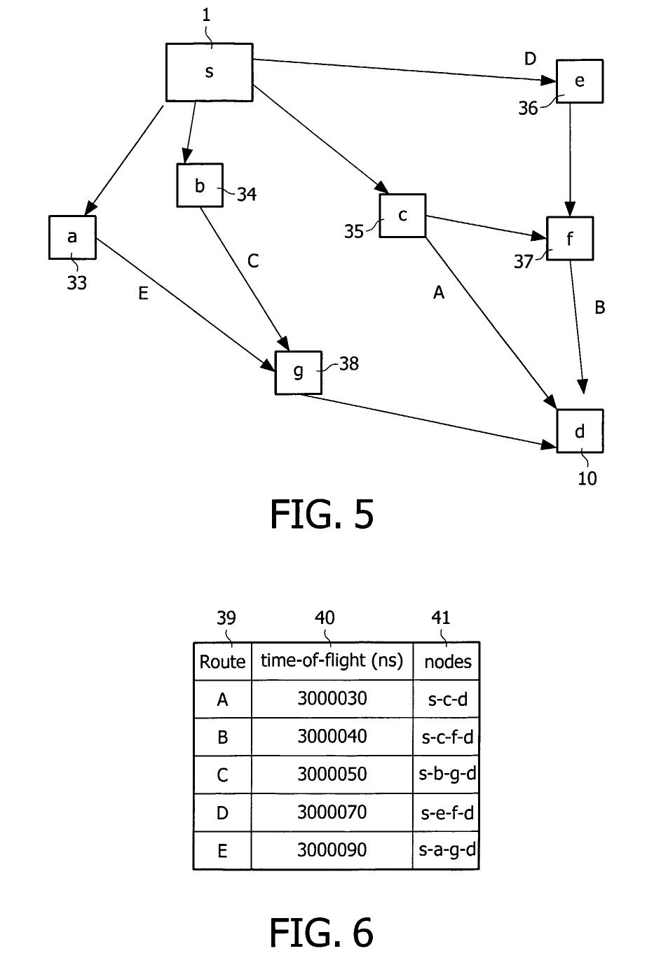

FIG. 5 illustrates different routes of transferring data between two nodes in a network;

FIGS. 6 shows an example of a table of data listing possible routes between two nodes in a network;

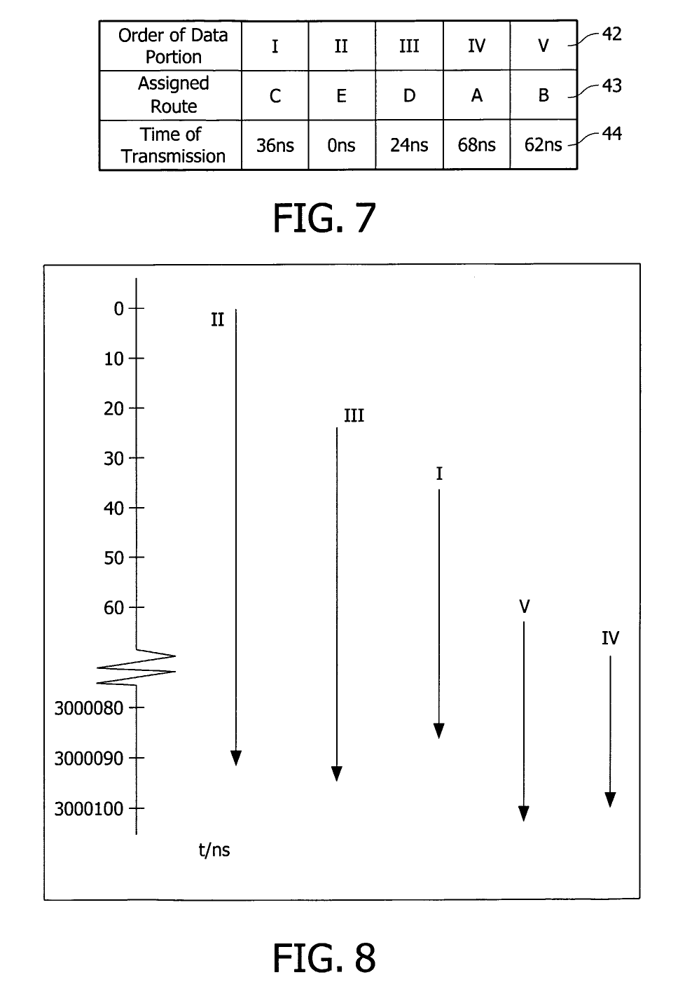

FIG. 7 shows an example of a table of data listing a plurality of data portions of a message, route data associated with each data portion and time of transmission of each data portion;

FIG. 8 is a graph showing the time of transmission and time of arrival of each data portion according to the data in FIG. 7;

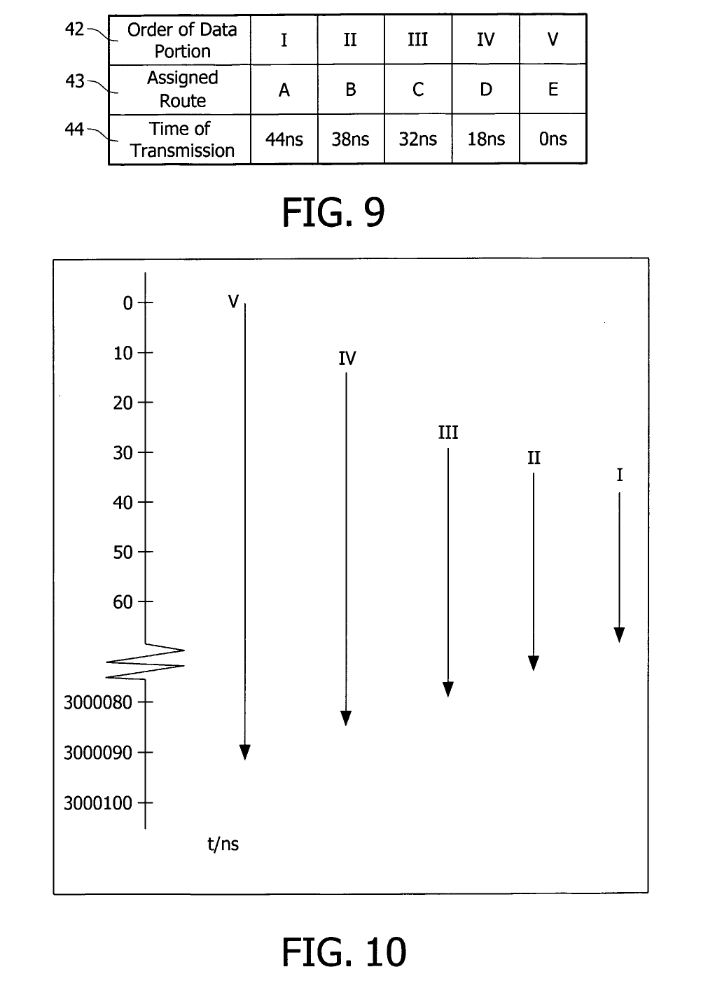

FIG. 9 shows another example of a table of data listing a plurality of data portions of a message, route data associated with each data portion and time of transmission of each data portion;

FIG. 10 is a graph showing the time of transmission and time of arrival of each data portion according to the data in FIG. 9; and

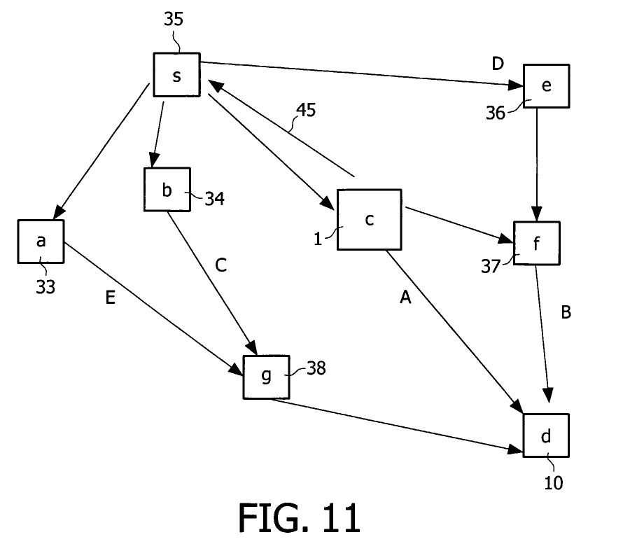

FIG. 11 illustrates different routes of transferring data between two nodes in a network in one embodiment of the invention.

Referring to FIG. 1, a device 1 providing a node for communication in a short-range network is shown. The node may be connected to a set-top box in the home used for controlling a short-range network connecting electronic equipment together, or it may be part of a portable device worn by a user of the short-range network. Device 1 comprises a short-range transceiver 2 for transmitting and receiving radio frequency signals 3, a central processing unit 4, memory (ROM) 5, storage (RAM) 6 and an internal clock 7 for synchronising with other nodes. In one embodiment, device 1 further comprises an input device 8 and a display 9 for communicating with a user. The device is further connected to a battery (not shown). The network requires at least one node acting as a network coordinator. A user can communicate with the network coordinator using input device 8 and display 9 and thereby control the network. Alternatively, the user can use a mobile phone or a Bluetooth™ device to communicate with the coordinator of the network. Thus, in an alternative embodiment, the coordinator may not comprise the input device 8 and the display 9.

Device 1 can act as a network coordinator. A network coordinator may have enhanced functionality compared to the other nodes in the network. For example, the network coordinator needs more memory and storage to set up the network, initiate devices connecting to the network and storing information about each of the nodes of the network. Referring to FIG. 2, an example of a device not acting as a network coordinator is shown. Device 10 comprises a short-range transceiver 11 for receiving and transmitting radio frequency signals 3, a central processing unit 12, memory (ROM) 13, storage (RAM) 14, and a clock 15. However, the processing unit 12 may have a lower processing capacity than the processing unit 4 of device 1 and the memory 13 and storage 14 of device 10 are smaller than the memory 5 and storage 6 of device 1. Consequently, device 10 may have lower power consumption than device 1 and its component may be cheaper. According to the invention, device 1 and device 10 communicate in a mesh network, i.e. every device, 1 and 10, can communicate directly with every other device, 1 and 10, within transmission range.

Preferably, device 10 and device 1 are compliant with ZigBee standards. However, the devices may also be compliant with other standards such as HomeRF, Bluetooth and IEEE 802.11x. According to the ZigBee standards 255 devices can be wirelessly connected to form a network, although a greater number of devices can be wirelessly connected using multiple ZigBee networks. A device can operate in 2.4 GHZ, 915 MHz and/or 868 MHz radio frequency bands, support raw data transfer rates of 250 kilobits per second (kbps), 40 kbps and 20 kbps respectively and have a transmission range typically between 10 and 75 metres. However, in order to lower the prices of the nodes the transmission range may be between 2 and 5 meters. An overview of the ZigBee standards may be obtained via the World Wide Web at www.zigbee.orci or from the ZigBee Alliance, Bishop Range, 22694 Bishop Drive, Suite 275, San Ramon, Calif. 94583, USA.

In one embodiment of the invention device 1 and device 10 are ZigBee devices operating according to the ZigBee standard. A protocol layer architecture of a ZigBee device is shown in FIG. 3. The device operates according to a protocol based on the IEEE 802.15.4 standard developed for short-range low power devices. This standard includes a physical (PHY) layer 16 controlling the communication between devices. The PHY protocol defines the overall structure of the data sent between devices, which is also referred to as the Physical Protocol Data Unit (PPDU) and which is shown in FIG. 4. The PPDU comprises the MAC (Medium Access Control) Protocol Data Unit, defined by the MAC Protocol Layer 17. The Mac protocol Layer 17 defines the type of data transmitted in the data unit and provides algorithms for encryption. According to the ZigBee standard the protocol stack also comprises the Network (NWK) Layer 18 and the Application Support (APS) Layer 19. The NWK Layer 18 includes the protocol for setting up the network, joining and leaving a network, enabling the coordinator to assign addresses to devices in the network, routing frames to their intended destination and applying and removing security to outgoing and incoming frames respectively. The MAC Layer 17 handles the security in single-hop transfers but the Network layer 18 handles the security in multi-hop transfers. The Application Support Layer 19 controls the ability to determine which other devices are operating in the personal operating space of a device and for matching two or more devices together based on their services and desires. The last layer, the Application Layer 20, allows the manufacturer to define application objects and implement the applications according to the ZigBee described application descriptions. The application layers also include ZigBee Device Objects that are responsible for defining the role of the node in the network, i.e. which node is the coordinator and which nodes are end nodes in the network.

The data is preferably sent between the nodes in the network in a Physical Protocol Data Unit (PPDU) as shown in FIG. 4. The PPDU comprises a synchronisation header including a preamble 21 and a frame delimiter 22. The preamble is a sequence of is and Os for announcing that a message is on the way. The Frame Delimiter 22 announces the start of the message. The Physical Header comprises a field 23 specifying the length of the remaining message. The remaining bytes of the data unit are defined by the MAC protocol 17 in the MAC Protocol Data Unit 24. It includes a header, the payload and the footer. The header includes the Frame Control field 25 for specifying the type of the frame and control data. There are four types of frames, the beacon frame, the data frame, the acknowledgement frame and the MAC command frame. The invention uses the data frame for transmitting data between a source node and a destination node. The MAC header further includes the Data Sequence Number 26 for checking, for example, which message in a sequence of messages a response or command refers to. An acknowledgment frame always has the same data sequence number as the frame of which it is acknowledging receipt. The MAC header also includes the Source Address field 27 and a Destination Address Field 28 specifying the 64 bit addresses of the source node and the destination node of the message respectively. A shorter 16-bit ZigBee address can be used in order to reduce the amount of data transmitted. The Mac footer includes a frame check sequence for error checking. Finally, the MAC payload includes the actual data 31. In one embodiment of the invention, the MAC payload unit also has a data header for specifying the route data 29 associated with the data unit and control data 30 for specifying additional data associated with the transmitted data. Field 29 and field 30 are discussed in more detail below.

Referring to FIG. 5, a mesh network having a coordinator node comprising a device 1 and nodes, a-e, comprising devices 10, 33-38 is shown. The nodes in the network regularly check the distances to the other nodes by a conventional method. The nodes further transmit information about the distances to their neighbours to the coordinator and the coordinator stores the information about the distances between neighbouring nodes in the network. If the coordinator is the source (s) for a message to be transferred to a destination node (d), the coordinator uses the Network Layer Protocol 18 to find an algorithm with which to perform the routing of the message between node s and node d. According to an example of a conventional method it would note the ZigBee address of the destination node, encrypt the message according to the MAC and Network Layer Protocols, 17 and 18, and transmit the message to all neighbouring devices. The nodes in direct communication with the source node (s) receive the message and check the destination address 28. If the devices know a route to the destination node, they transmit the message to all neighbouring devices and send acknowledgement messages back to the source node. Alternatively, source routing can be exploited, wherein the coordinator analyses all possible routes considering the time-of-flight of each route and the data rate capabilities of each node, finds the most appropriate route and includes a route field 29 in the data header specifying the addresses of the nodes included in the route. A node along the route checks the data route field and forwards the data to the next node along the route.

According to the invention, the coordinator uses the stored distance data to determine a plurality of possible routes to the destination route and calculates the time of flight of the data from the source node to the destination node along each particular route. FIG. 5 shows five different routes A-E between the source node, s, and the destination node, d, wherein each route A-E takes successively longer time. The coordinator then arranges the message into a ordered sequence of data portions, notes the order of each data portion such that the message can be put back together, assigns a route to each of the data portions, adds a data portion along with route data 29 to the MAC Payload 31 of a MAC data frame and transmits each data unit at the correct time such that the data portions appear in the right order at the destination node. By using this method, no encryption is required since the only place where an eavesdropper is able to receive the complete message in the right order is at the exact location of the destination device. Thus, little processing is required at the destination node. Most of the processing can be done at the controller and the destination device can have reduced functionality and processing capacity.

FIG. 6 shows details of each of the selected routes, A-E, in the network. A large number of different routes means increased security, due to that if every data portion takes a different route, intercepting enough data to understand the message is more difficult. Moreover, the selection of routes used between two nodes can be updated with every message making eavesdropping on the message even more difficult. The table in FIG. 6 is stored in the RAM of the controller. The first column 39 lists identification data for each route and the second column, 40, lists the time it takes to send data along the route. A typical network has an average transmission time between two nodes of a few milliseconds. As the nodes along the route are only forwarding the data, each node adds very little overhead in transmission times to the data. The delays between the fastest and the slowest route can be less than 100 ns. The values in column 40 are only for illustrative purposes and are given in nanoseconds. The third column, 41, lists the nodes in the network that lie along each route. The route assigned to each portion may be chosen at random or according to an optimising algorithm.

FIG. 7 shows a table of data listing all portions, row 42, their assigned routes, row 43, and times of transmissions, row 44. The times of transmissions are calculated such that the portions arrive in the right order at the destination node. As an example, the time period between the arrivals of successive data portion at the destination node is chosen to be at least 4 ns. In order to reduce the time it takes to send the complete set of data portions the data portion sent along the longest route is sent first and the data portion sent along the shortest route is sent last. In the example in FIG. 7, the routes have been assigned at random and the second portion in the ordered sequence of data portions, data portion II, is assigned route E, the longest route. If the time of transmission of data portion II is defined as 0 ns, data portion II will arrive at the destination node at 3090 ns. Data portion I, which is the first data portion in the ordered sequence of data portions needs to arrive at the destination node at least 4 ns before data portion II. Thus, it needs to arrive at 3086 ns. Data portion I has been assigned route C, which takes 3050 ns. Consequently, data portion I needs to be transmitted at 36 ns. The transmission times of data portions III, IV and V are calculated using similar analyses.

Before sending the message, the order of each data portion may be included in the Data control field 30 in the Data header such that the receiving device may check that the data portions are received in the right order. The route as specified in column 41 is included in route data field 29. Thus, each node that receives a data portion checks the destination address field and if the destination address does not correspond to the address of the node, it looks up the route data 29 and forwards the data unit to the next node along the route.

FIG. 8 illustrates the times of transmission and times of arrival of each data portion according to the data in FIG. 7. The time axis is cut in order to illustrate realistic transmission times while still having a high time resolution at the time of transmission and the time of reception of the data. The graph clearly shows that the data portions are received in the right order at the destination node. It is further clear from FIG. 8 that the data portion, II, sent along the slowest route, E, is sent first and the data portion, IV, sent along the quickest route, A, is sent last. In this example the time between the transmission of the first transmitted data portion and the time when all data portions have been received is 3000102 ns, whereas if all the portions had been sent along the shortest route it would have been 3000030 ns. Consequently, the message is delayed by 72 ns compared to if all the data portions had been sent at the same time along the shortest route.

This time delay can be further reduced if the data portions are assigned routes according to their order in the ordered sequence of data portions. Since the first data portion in the ordered sequence of data portions should be the first data portion to be received at the destination node, the time delay can be reduced by sending the first data portion by the longest route. Data portions from the end of the ordered sequence can be transmitted along successively shorter routes. FIG. 9 and FIG. 10 illustrates the transmission and arrival times of the different portions when they are sent according to this algorithm. The actual time of delay will be the time it takes for the slowest portion to arrive as show in FIG. 10.

FIG. 11 further shows a number of routes between two nodes in a network wherein neither the source node or destination source of a message is the coordinator. The source node comprises device 35 similar to device 10 and the destination node comprises device 10. According to one embodiment of the invention, routing information is requested by device 35 from the coordinator, device 1. The coordinator sends a signal 45 comprising the table shown in FIG. 9 to device 35. The source node arranges the message into five portions of data and transmits each data portion according to the routing information comprised in the table received from the coordinator. Alternatively, the coordinator may only send the table shown in FIG. 6 to the source node if the source node has enough processing power to calculate the time of transmission of each data portion and assign the relevant route.

An example of where a method and an apparatus, in accordance with the invention, could be used involves an office building wherein nodes are attached to the light switches, locks and electronic appliances in the building. The coordinating node of the network may be attached to a device in a central location of the building. A person who works in the building has configured her personal device 35 such that when she enters the building in the morning, the door to her office is unlocked and the light is turned on. Similarly, when she leaves the building, the door to her office is locked and the light switched off. Consequently, her portable device needs to send a secure password to the node attached to the door of her office, in order-to lock/unlock the door. Thus, when the office worker enters the main door to the building, a message is transmitted to the coordinator of the network requesting routing information between the portable node and the node attached to the office door. The coordinator sends updated routing information to portable device 35. It is possible that the nodes of the network have changed location in the building since the worker was last there and consequently, the routing information may have changed. The portable device 35 sends the password and instructions to destination node 10 connected to the office door along routes A to E. Node 10 receives the portions in the right order and reads the password and the instructions. Thus, when the user reaches his office, the door is unlocked and the light is switched on.

The examples of embodiments of the invention are only meant to illustrate the invention and are not restrictive. The invention can be exploited in all kinds of ad hoc networks and the devices do not need to operate according to the ZigBee Standard.

Although Claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any Claim and whether or not it mitigates any or all of the same technical problems as does the present invention. The Applicants hereby give notice that new Claims may be formulated to such features and/or combinations of such features during the prosecution of the present Application or of any further Application derived therefrom.

1. A method of transmitting a message comprising a sequence of ordered data portions (I-V) between a source node (s) and a destination node (d) in a network, the method comprising
assigning a route from a plurality of different routes (A-E) to each of the data portions (I-V), and
transmitting each of the data portions (I-V) at a specific time based on the assigned route and order such that the portions are received in the ordered sequence at the destination node (d).

2. The method of claim 1 further comprising the source node (s) not being within the transmission range of the destination (d) node and each route (A-E) comprising at least one node (a-c, e-g) for forwarding the data portion.

3. The method of claim 2, wherein said data portion comprises route data (29) specifying the addresses of the at least one node along the route (a-c, e-g).

4. The method of claim 3 further comprising each of the at least one node (a-c, e-g) along the route receiving the data portion (I-V), checking said route data (29) associated with the data portion and forwarding the portion to the next node indicated by said route data.

5. The method of claim 4 wherein the data portion and the route data are included in a Media Access Control data frame (25-32).

6. The method of claim 1, wherein each route (A-E) is selected with consideration to the information on the distances between nodes in the network.

7. The method of claim 1, wherein the network has a coordinator node (1) and the coordinator stores the information on the distances between nodes in the network in the storage (6) of the coordinator node.

8. The method of claim 7 wherein said information stored in the network coordinator is changed in response to a change in position of a network node.

9. The method of claim 7 wherein the source node (s) is not the network coordinator, the source node (s) requests route data to a destination node (d) from the network coordinator (1) and the coordinator sends route data to the source node.

10. The method of claim 9 wherein the route data comprises a plurality of available routes between the source node and the destination node and the time of flight of data along each of the plurality of routes (39, 40, 41).

11. The method of claim 10 wherein the route data further comprises the information about which route is assigned to each data portion and when to transmit each of the data portions (42,43,44).

12. The method of claim 1 wherein the data portion assigned the longest route is transmitted first.

13. The method of claim 1 wherein the data portion assigned the shortest route is transmitted last.

14. The method according to claim 1 wherein the data portions are assigned routes in dependence on said order of the data portion in the ordered sequence.

15. The method according to claim 14 wherein a data portion from the beginning of the ordered sequence is assigned a longer route than a data portion from the end of the ordered sequence.

16. The method according to claim 1 wherein the data is sent using the IEEE 802.15.4 protocol (16, 17).

17. The method according to claim 1 wherein the data is sent using the ZigBee standard.

18. A device (1, 10) adapted to be used in a wireless network comprising a plurality of nodes for transmitting a message comprising an ordered sequence of data portions (I-V) through the network to a destination node (d) comprising
transmission means (2, 11) for transmitting each of the data portions (I-V) along a different route (A-E) and at a different time based on said route and order such that the data portions (I-V) are received in the ordered sequence at the destination node (d).

19. The device (1, 10) as in claim 18, further having storage means (6, 14) for storing data about the distance between individual nodes in the network,
calculation means (4, 12) for calculating the time-of-flight along a plurality of routes between a source node and a destination node in the network, and
selecting means (4, 12) for selecting a route for each of said data portions, wherein
the calculation means are further configured to calculate the time of transmission of each data portions such that the portions arrive at the destination node in the ordered sequence.

20. The device (1, 10) according to claim 18 wherein the device is a ZigBee device or a Bluetooth device.

21. The device (1, 10) according to claim 18 wherein the device operates according to the IEEE 802.15.4 standard.

22. A network comprising a plurality of nodes as claimed in claim 18.

23. A network as in claim 22 comprising a mesh network.

24. A network as in claim 22 wherein the plurality of nodes includes a coordinating node for supplying route information to other nodes when requested.
